(19) United States
(12) Patent Application Publication
(10) Pub. No.: US 2009/0119540 A1
(43) Pub. Date: May 7, 2009

(54) Device and method for performing switchover operations in a computer system having at least two execution units

(76) Inventors: Reinhard Weiberle, Vailhingen-Enz (DE); Bernd Mueller, Gerlingen (DE); Yorck Collani, Beilstein (DE); Rainer Gmehlich, Ditzingen (DE); Eberhard Boehl, Reutlingen (DE)

Correspondence Address: KENYON & KENYON LLP, ONE BROADWAY, NEW YORK, NY, 10004, US

(21) Appl. No.: 11/666,260

(22) PCT Filed: Oct. 25, 2005
(86) PCT No.: PCT/EP05/55499

§ 371 Date: Apr. 24, 2007

(30) Foreign Application Priority Data
Oct. 25, 2004 (DE) 102004051937.4
Oct. 25, 2004 (DE) 102004051950.1
Oct. 25, 2004 (DE) 102004051952.8
Oct. 25, 2004 (DE) 102004051964.1
Oct. 25, 2004 (DE) 102004051992.7
Aug. 8, 2005 (DE) 102005037224.4

(51) Int. Cl. G06F 11/16

(52) U.S. Cl. 714/10; 714/E11.054

(57) ABSTRACT

A device and method for performing switchover operations in a computer system having at least two execution units, a changeover switch being provided which switches between at least two operating modes, a first operating mode corresponding to a comparison mode, and a second operating mode corresponding to a performance mode, in addition, a comparator being provided which is activated in the comparison mode, in which an arrangement provides desired switchover detection, the arrangement for desired switchover detection controlling the changeover switch in order to switch from one operating mode to another.

### FIELD OF THE INVENTION

The present invention relates to a device for performing switchover operations in a computer system having at least two execution units, a changeover switch which switches between at least two operating modes, a first operating mode corresponding to a comparison mode, a second operating mode corresponding to a performance mode, and a comparator that is activated in the comparison mode.

### BACKGROUND INFORMATION

Transient faults, triggered by alpha particles or cosmic radiation, are increasingly becoming a problem for integrated semiconductor circuits. Due to diminishing structure widths, declining voltages and higher clock frequencies, there is an increased probability of a voltage peak, caused by an alpha particle or cosmic radiation, falsifying a logic value in an integrated circuit. This may result in an erroneous calculation. It is, therefore, essential that such faults be reliably detected in safety-related systems, particularly in motor vehicles. In safety-related systems, such as in ABS control systems in motor vehicles, which necessitate reliable detection of malfunctions in the electronics, redundancies for detecting faults are typically employed in the relevant control devices of such systems. Thus, for example, in known ABS systems, the complete microcontroller is duplicated in each instance, the entire ABS functions being redundantly calculated and checked for conformity. If there is a discrepancy in the results, the ABS system is switched off.

The essential components of a microcontroller are memory modules (such as RAM, ROM, cache), the cores and the input/output interfaces, the so-called peripherals (for instance A/D converter, CAN interface). Since the memory elements are able to be effectively monitored using check codes (parity or ECC), and the peripherals are frequently monitored as part of a sensor signal path or actuator signal path as a function of the particular application, an additional redundancy approach is provided by merely doubling the cores of a microcontroller.

Such microcontrollers having two integrated cores are also known as dual-core architectures. Both cores execute the same program segment redundantly and in a clock-synchronized mode (lockstep mode); the results of the two cores are compared, and a fault is then recognized in the conformity-check comparison. This configuration of a dual-core system may also be described as a comparison mode.

Dual-core architectures are also used in other applications to enhance performance, thus to increase performance. The two cores execute different programs, program segments and instructions, thereby making it possible to increase performance, so that such a dual-core system configuration can also be termed performance mode. Such a system is also known as a symmetrical multiprocessor system (SMP).

These systems are expanded by using software to switch between these two modes, in that a special address is accessed, and specialized hardware devices are used. In the comparison mode, the output signals of the cores are compared to each other. In the performance mode, the two cores function as a symmetrical multiprocessor system (SMP) and execute different programs, program segments or instructions.

In such systems, it is important to recognize the request for switching a mode and to then control a changeover switch accordingly.

### SUMMARY OF THE INVENTION

An object of the exemplary embodiments and/or exemplary methods of the present invention to devise an arrangement and methods which will make it possible for such a request to be recognized.

A device for performing switchover operations in a computer system having at least two execution units is advantageously employed, a changeover switch being provided which switches between at least two operating modes, a first operating mode corresponding to a comparison mode, and a second operating mode corresponding to a performance mode, in addition, a comparator being provided which is activated in the comparison mode, characterized in that an arrangement for desired switchover detection is provided, the arrangement for desired switchover detection control the changeover switch in order to change over from one operating mode to another.

A device is advantageously employed in which the arrangement for desired switchover detection and the changeover switch are combined in one component of the computer system, in particular in one structural unit.

A device is advantageously employed in which the comparator and the changeover switch are combined in one component of the computer system, in particular in one structural unit.

A device is advantageously employed in which the arrangement for desired switchover detection and the comparator are combined in one component of the computer system, in particular in one structural unit.

A device is advantageously employed in which the comparator, the arrangement for desired switchover detection and the changeover switch are combined in one component of the computer system, in particular in one structural unit.

A device is advantageously employed in which, in the computer system, data and instructions are processed in two pipelines, the pipelines being set up in different stages, and the arrangement for desired switchover detection corresponding to a separate pipeline stage.

A method for performing switchover operations in a computer system having at least two execution units is advantageously employed, switchover operations being carried out between at least two operating modes, and a first operating mode corresponding to a comparison mode and a second operating mode corresponding to a performance mode, a comparator being activated in the comparison mode, characterized in that a desired switchover detection and a changeover switch controlled by the desired switchover detection are provided in order to switch from one operating mode to another.

A method is advantageously employed in which the arrangement for desired switchover detection generate a switchover signal which triggers a switchover operation by the changeover switch.

A method is advantageously employed in which the comparator and the changeover switch are combined in one component of the computer system to form a switchover and comparison unit, and the arrangement for desired switchover detection generate a switchover signal which triggers a switchover operation by the switchover and comparison unit.

Other advantages and advantageous embodiments are described herein.

### BRIEF DESCRIPTION OF THE DRAWINGS

FIG. 1 shows a multiprocessor system G60 having two execution units G10a, G10b, a comparison unit G20, a switchover unit G50, and a unit for desired switchover detection G40.

FIG. 2 shows a multiprocessor system G60 having two execution units G10a, G10b of one combined comparison and switchover unit G70 made up of a comparison unit G20 and of a switchover unit G50, and of a unit for desired switchover detection G40.

FIG. 3 shows a multiprocessor system G60 having two execution units G10a, G10b of a combined desired switchover detection, comparison and switchover unit G80 made up of a comparison unit G20 and of a switchover unit G50, and of a unit for desired switchover detection G40.

FIG. 4 shows a multiprocessor system G200 having two execution units G210a, G210b of a switchover and comparison unit G260.

FIG. 5 shows, in a flow chart representation, a method which provides for a special undefined bit combination to be exchanged with an NOP or other neutral bit combination, within a special pipeline stage G230a, G230b.

FIG. 6 shows a multiprocessor system H200 having two execution units H210a, H210b and a switchover and comparison unit H260.

FIG. 7 shows, in a flow chart, a method illustrating how, with the aid of the unit IDs, the program flow is able to be separated when the switch is made from a comparison mode to a performance mode in a multiprocessor system having two execution units.

FIG. 8 shows one method illustrating how, with the aid of the unit IDs, the program flow is able to be separated when the switch is made from a comparison mode to a performance mode in a multiprocessor system having three execution units.

FIG. 9 shows, in a flow chart, a method for synchronizing the execution units when the switch is made from the performance mode to the comparison mode.

FIG. 10 shows a finite automaton, which represents the switch between a performance and a comparison mode.

FIG. 11 shows a multiprocessor system G400 having two execution units, as well as two interrupt controllers G420a, G420b, including interrupt masking registers G430a, G430b contained therein and various interrupt sources G440a through G440n.

FIG. 12 shows a multiprocessor system having two execution units, a switchover and comparison unit, and an interrupt controller having three register records.

FIG. 13 shows the simplest form of a comparator.

FIG. 14 shows a comparator having a unit for compensating for a phase shift.

FIG. 15 illustrates the fundamental performance characteristics of a component M700 (switchover and comparison unit) in the comparison mode.

FIG. 16 illustrates the fundamental performance characteristics of a component M700 (switchover and comparison unit) in the performance mode.

FIG. 17 shows one specific embodiment of the switchover and comparison unit.

FIG. 18 shows another specific embodiment of the switchover and comparison unit.

FIG. 19 shows a switchover and comparison unit which generates a mode signal.

FIG. 20 shows a general illustration of a switchover and comparison unit.

FIG. 21 shows an illustration of a switchover and comparison unit which generates a general mode and a general error signal.

FIG. 22 shows the query/reply communication with an external unit.

FIG. 23 illustrates the communication with an intelligent actuator.

### DETAILED DESCRIPTION

A processor, a core, a CPU, as well as an FPU (floating point unit), a DSP (digital signal processor), a coprocessor or an ALU (arithmetic logical unit) may all be termed execution unit in the following.

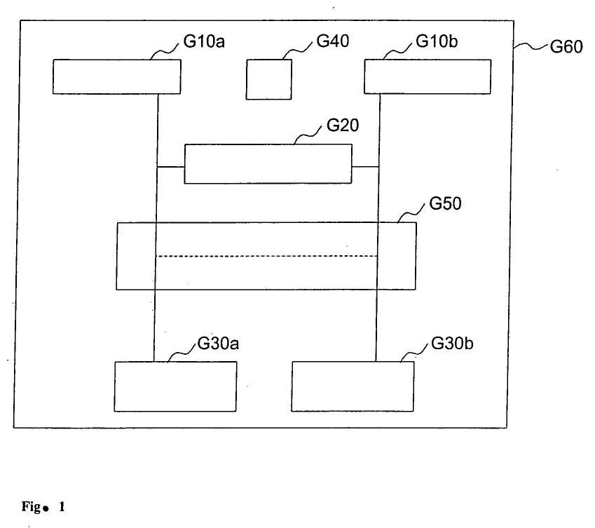

FIG. 1 shows a multiprocessor system G60 having two execution units G10a, G10b, a comparison unit G20, a switchover unit G50, and a unit for desired switchover detection G40.

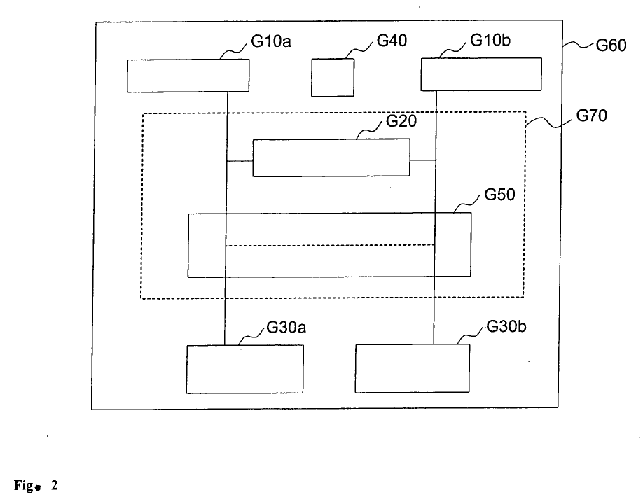

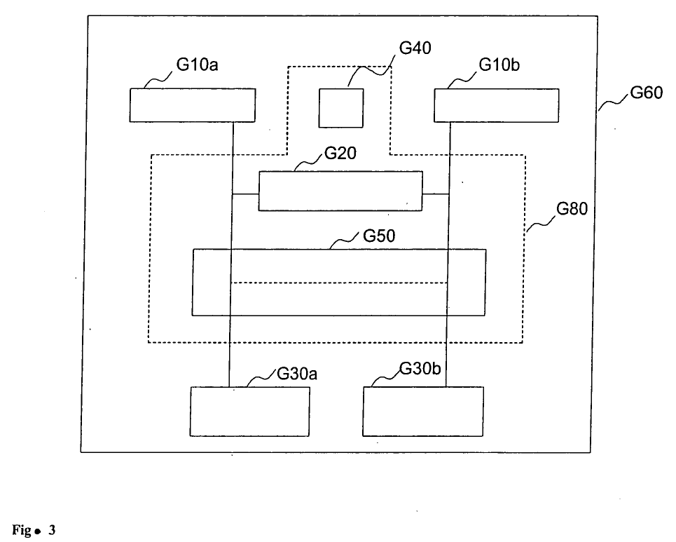

The exemplary embodiments and/or exemplary methods of the present invention relates to a multiprocessor system G60, as shown in FIG. 1, FIG. 2, FIG. 3, having at least two execution units G10a, G10b, a comparison unit G20, a switchover unit G50, and a unit for desired switchover detection G40. Switchover unit G50 has at least two outputs to at least two system interfaces G30a, G30b. Via these interfaces, registers, memories or peripherals, such as digital outputs, D/A converters, and communications controllers, may be controlled. This multiprocessor system may be operated in at least two operating modes, one comparison mode (VM) and one performance mode (PM).

In the performance mode, different instructions, program segments or programs are executed in parallel in the different execution units. In this operating mode, comparison unit G20 is deactivated. In this operating mode, switchover unit G50 is configured in such a way that each execution unit G10a, G10b is linked to a system interface G30a, G30b. In this context, execution unit G10a is linked to system interface G30a and execution unit G10b to system interface G30b.

In the comparison mode, the same or substantially similar instructions, program segments or programs are processed in both execution units G10a, G10b. These instructions are beneficially processed in clock-controlled synchronism, however, a processing in asynchronous operation or with a defined clock pulse offset is also conceivable. The output signals of execution units G10a, G10b are compared in comparison unit G20. In the case of a difference, a fault is detected, and appropriate measures may be taken. These measures may trigger an error signal, initiate a fault handling, actuate switches, or constitute a combination of these and other conceivable measures. In one variation, switchover unit G50 is configured in such a way that only one signal is transmitted to system interfaces G30a, G30b. In another configuration, the effect of the switchover unit is such that only the compared and thus substantially identical signals are transmitted to system interfaces G30a, G30b. Independently of the currently active mode, desired switchover detection G40 detects a request to switch to a different mode.

FIG. 2 shows a multiprocessor system G60 having two execution units G10a, G10b of one combined comparison and switchover unit G70 made up of a comparison unit G20 and of a switchover unit G50, and of a unit for desired switchover detection G40.

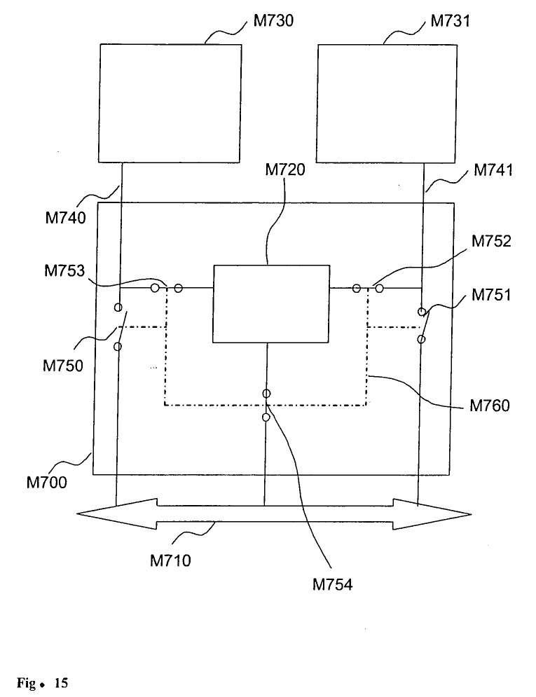

In one specific embodiment of the above described subject matter, switchover unit G50 and comparison unit G20 may be combined to form one shared switchover and comparison unit (SCU) G70, as shown in FIG. 2. This shared component G70 then assumes the tasks of individual components G50, G20. Variants of SCU G70 are illustrated in FIGS. 15, 16, 17, 18 and 19.

In another specific embodiment, as shown in FIG. 3, unit for desired switchover detection G40, comparator G20, and switchover unit G50 may be combined to form one shared component G80. In another specific embodiment that is not shown in any figure, unit for desired switchover detection G40 and comparator G20 may be combined into one shared component. Likewise conceivable is combining unit for desired switchover detection G40 and switchover unit G50 to form one shared component.

Unless indicated otherwise, it is assumed in the following that a unit for desired switchover detection G40 and a combined switchover and comparison unit G70 are present.

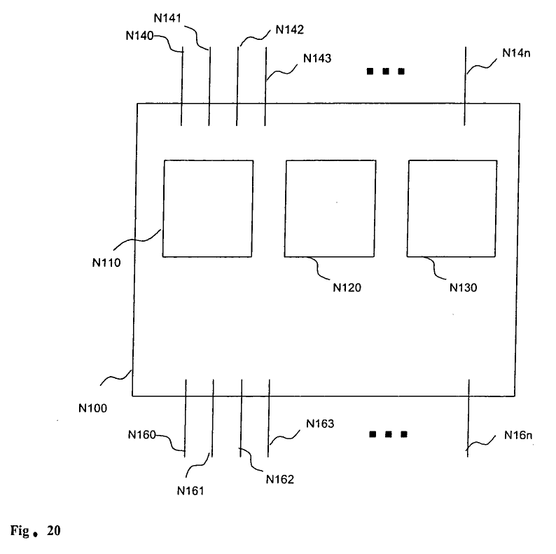

A typical example of the switchover and comparison component, also for use with more than two execution units, is shown in FIG. 20. Of the n execution units to be considered, n signals N140, . . . , N14n are transmitted to switchover and comparison component N100. From these input signals, this component is able to generate up to n output signals N160, . . . , N16n. In the simplest case, the “pure performance mode,” all signals N14i are routed to the corresponding output signals N16i. In the opposite limiting case, the “pure comparison mode,” all signals N140, . . . , N14n are routed to only precisely one of output signals N16i.

This figure illustrates how the different conceivable modes may be formed. To this end, the logic component of a switching logic N110 is included in this figure. This component does not necessarily need to be provided as a separate component. What is decisive is that the described functions are realized in the system. Switching logic N110 first establishes how many output signals are actually present. It also establishes which input signals contribute to which output signals. In this context, one input signal may contribute to exactly one output signal. Formulated mathematically, the switching logic thus defines a function that assigns one element of set {N160, . . . , N16n} to each element of set {N140, . . . , N14n}.

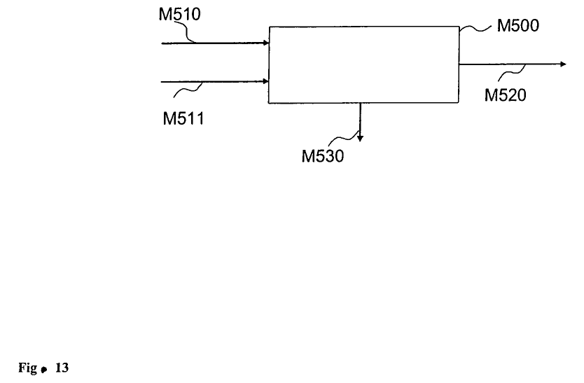

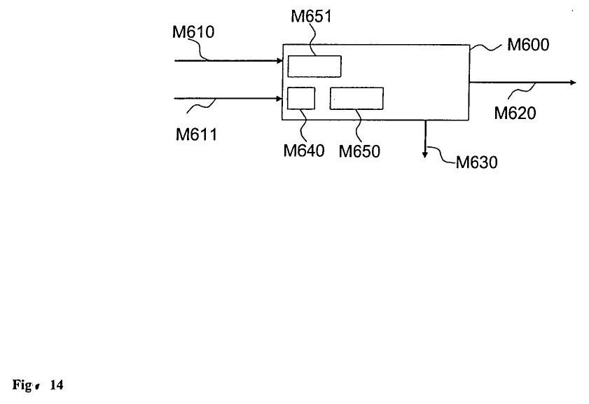

For each of outputs N16i, processing logic N120 then establishes the form in which the inputs contribute to this output signal. This component also does not necessarily need to be present as a separate component. Decisive, again, is that the described functions be implemented in the system. To describe the different variations exemplarily, it is assumed, without limiting universality, that output N160 is generated by signals N141, . . . , N14m. If m=1, this simply corresponds to the signal being switched through; if m=2, then signals N141, N142 are compared, as described, for example, with regard to the comparator in FIGS. 13 and 14. This comparison may be implemented synchronously or asynchronously; it may be performed on a bit-by-bit basis, or only for significant bits or also using one tolerance band.

In the case that m≧3, a plurality of options is provided.

A first option provides for comparing all signals, and, if at least two different values are present, for a fault to be detected that may optionally be signaled.

A second option provides for undertaking a k out of m selection (k>m/2). This may be implemented through the use of comparators. An error signal may be optionally generated when it is ascertained that one of the signals is deviant. A possibly differing error signal may be generated when all three signals are different.

A third option provides for supplying these values to an algorithm. This may represent, for instance, the forming of an average value, a median value, or the use of a fault-tolerant algorithm (FTA). Such an FTA is based on deletion of the extreme values of the input values and on a type of averaging of the remaining values. This averaging process may be undertaken for the entire set of the remaining values or which may be for a subset that is easily formed in HW. In such a case, it is not always necessary to actually compare the values. In the averaging operation, it is merely necessary to add and divide, for example; FTM, FTA or median value (generation) require partial sorting. If indicated, an error signal may optionally be output here as well, given high enough extreme values.

For the sake of brevity, these various mentioned options for processing a plurality of signals to form one signal are described as comparison operations.

Thus, the task of the processing logic is to establish the exact form of the comparison operation for each output signal, and thus also for the corresponding input signals. The combination of the information of switching logic N110 (that is, the above mentioned function) and the processing logic (that is, the establishment of the comparison operation per output signal, i.e., per functional value) is the mode information; and this determines the mode. Generally, this information is naturally multi-valued, i.e., not representable by only one logic bit. Not all theoretically conceivable modes are practical in a given implementation; one may limit the number of permitted modes. It is important to note that, in the case of only two execution units, where there is only one comparison mode, the entire information may be condensed to only one logic bit.

A switch from a performance mode to a comparison mode is generally characterized in that execution units, which, in the performance mode, are mapped to different outputs, are mapped to the same output in the comparison mode. This is may be implemented in that a subsystem of execution units is provided, in which, in the performance mode, all input signals N14i, which are to be considered in the subsystem, are directly switched to corresponding output signals N16i, while, in the comparison mode, they are all mapped to an output. Alternatively, such a switchover operation may also be implemented by altering pairings. The explanation for this is that, generally, it is not possible to speak of the one performance mode and the one comparison mode, although, in one specific embodiment of the present invention, the number of permitted modes may be limited in such a way that this general case does apply. However, it is always possible to speak of a switch from a performance mode to a comparison mode (and vice versa).

Software-controlled, dynamic switchover operations between these modes may be dynamically carried out during operation. In this context, the switchover operation is triggered by the execution of special switchover instructions, special instruction sequences, explicitly identified instructions or in response to the accessing of specific addresses by at least one of the execution units of the multiprocessor system.

Fault-switching logic N130 collects the error signals, which are generated by the comparators, for example, and may optionally switch outputs N16i to passive by interrupting the same via a switch, for instance.

For the most part, however, the examples in the following focus on two execution units suited for presenting most of the concepts.

Different methods may be used for encoding the switchover between the modes. One possible method requires that special switchover instructions be used, which are detected by unit for desired switchover detection G40. Another possible method for encoding the switchover operation is defined by the accessing of a special memory area, which is again detected by unit for desired switchover detection G40. In another method, an external signal, signaling a switchover operation, is evaluated in unit for desired switchover detection G40. In the following, a method is described which employs unused bit combinations in the existing instruction set of the processor. A special advantage of this method is that existing development environments (assemblers, compilers, linkers, debuggers) may continue to be used.

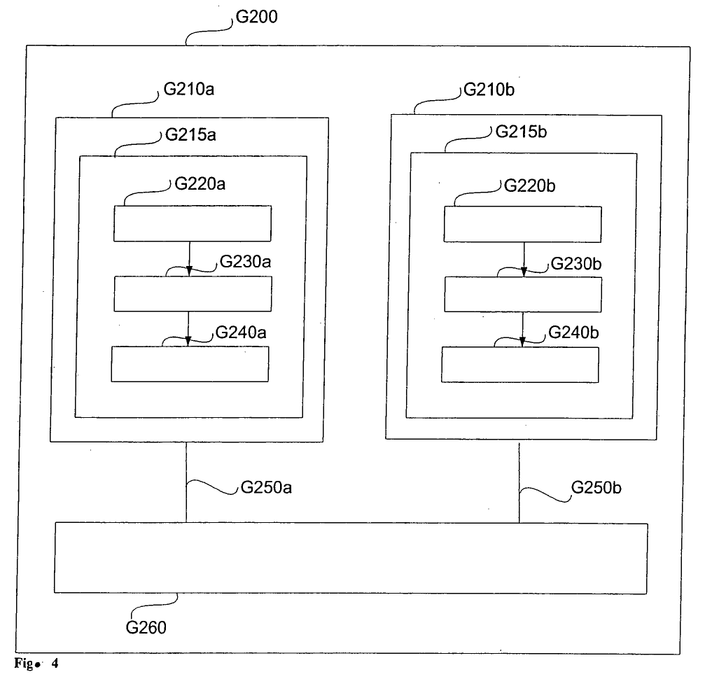

FIG. 4 shows a multiprocessor system G200 having two execution units G210a, G210b and a switchover and comparison unit G260. To switch between a comparison mode and a performance mode (and vice versa), undefined bit combinations of the at least two execution units G210a, G210b are used in the assembler. In this context, undefined bit combinations are understood to be all bit combinations specified in the description of the instruction set as being undefined or illegal. These include, for example, illegal operand, illegal instruction, and illegal operation. A general characteristic of these undefined bit combinations is that a normal execution unit either generates an error signal or exhibits an undefined performance characteristic when executing such a bit combination. Thus, these bit combinations are not needed for representing the semantics of a standard program.

Therefore, the existing development environment provided for single-processor systems may be used for the software development. This may be implemented, for example, by defining a macro “SWITCH MODE TO PM” and a macro “SWITCH MODE TO VM” which, at an appropriate location in the code, inserts appropriate bit combinations that are undefined within the above defined meaning.

The use of this combination is then defined as a general “SWITCH” macro. This then effects a change of the current mode, as a function thereof, into the other respective mode. If more than two different modes are present in the system, then this method requires that more such combinations be available; one may then be used for each mode for purposes of switchover identification.

In accordance with the exemplary embodiments and/or exemplary methods of the present invention, the switchover request is then encoded by a bit combination that is not defined in the instruction set. These may not be processed in the usual manner within an execution unit G210a, G210b. For this reason, an additional pipeline stage (REPLACE stage) G230a, G230b is proposed, which recognizes the corresponding bit combinations and replaces them with neutral bit combinations for further processing.

To this end, the “NOP” (no operation) instruction is advantageously used. A NOP instruction is characterized in that it does not change the internal state of the execution unit, except for the instruction indicator. In the process, REPLACE stage G230a, G230b is inserted following the typically first stage, FETCH stage G220a, G220b; and undefined bit combinations in the assembler, which are combined into one unit here, are inserted before the remaining pipeline stages G240a, G240b.

In accordance with the exemplary embodiments and/or exemplary methods of the present invention, the implementation, presented here, of a unit for desired switchover detection G40 as special pipeline stage G230a, G230b in a pipeline unit G215a, G215b will generate additional signals G250a, G250b in response to detection of a corresponding bit combination for switchover, thereby signaling to a separate switchover unit and comparison unit G260 that the processing mode must be changed.

REP stages G230a, G230b may be situated between FET G220a, G220b and the remaining pipeline stages G240a, G240b in pipeline units G215a, G215b of execution units G210a, G210b. In the process, REP stages G230a, G230b detect the corresponding bit combinations and, in this case, route NOP instructions to the remaining stages G240a, G240b. At the same time, signal G250a or G250b in question is activated. In all other cases, REP stages G230a, G230b have neutral performance characteristics; i.e., all other instructions are passed on, unchanged, to remaining stages G240a, G240b.

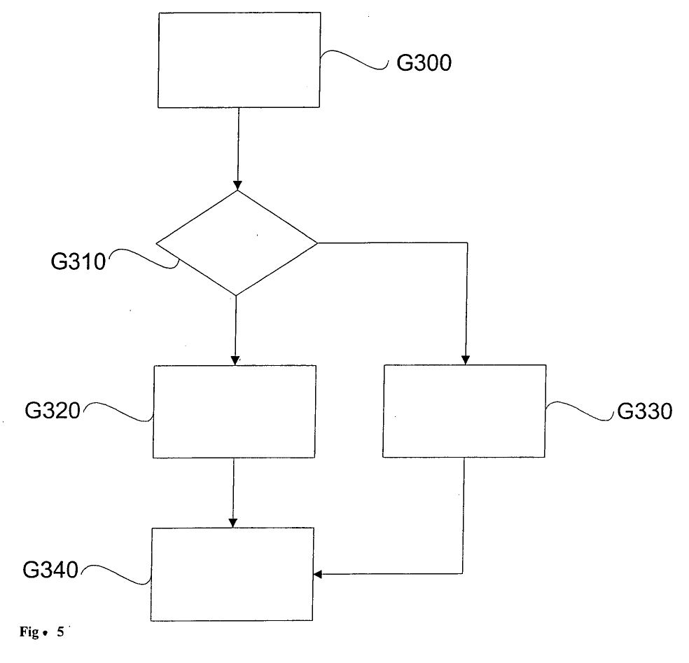

In a flow chart representation, FIG. 5 illustrates a method which provides for a special undefined bit combination to be exchanged with an NOP or other neutral bit combination, within a special pipeline stage G230a, G230b. In FETCH step G300, an instruction, i.e., a bit combination is fetched from the memory. It is subsequently decided in block G310 whether the fetched bit combination corresponds to the special undefined bit combination which encodes a switchover. If this is not the case, in next step G320, the bit combination is transmitted, unchanged, to the remaining pipeline stages G340 for further processing. If the special bit combination, which encodes a switchover, is detected in step G310, then it is replaced in step G330 by the NOP bit combination, which is then transmitted to additional pipeline stages G340 for further processing. In one advantageous specific embodiment, blocks G310, G320, G330 represent the functionality of a REPLACE stage G230a, G230b according to the exemplary embodiments and/or exemplary methods of the present invention, which may also include additional functionality.

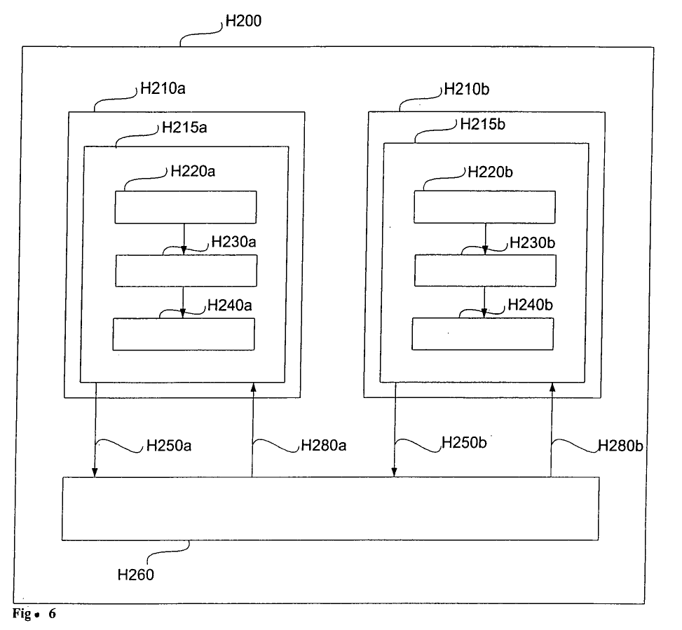

FIG. 6 shows a multiprocessor system H200 having two execution units H210a, H210b and a switchover and comparison unit H260. Components H220a, H220b, H240a, H240b are equivalent to G220a, G220b, G240a, G240b. One alternative embodiment of unit for desired switchover detection G40, described here by special pipeline stages H230a, H230b, provides for it to include additional signals besides signals H250a, H250b which signal a switchover operation. To enable execution units H210a, H210b to be synchronized when the change is made from the performance mode to the comparison mode, pipeline units H215a, H215b of execution units H210a, H210b each have a signal input H280a, H280b that may be used to stop the processing. This signal is set by switchover and comparison unit H260 for that pipeline unit H215a or H215b which is the first to detect a switchover instruction and thus to activate signal H250a or GH50b. Not until both pipeline units H215a, H215b of execution units H210a, H210b have detected the switchover instruction and have synchronized their internal states using software or other hardware measures, is this signal H280a, H280b canceled again. When the change is made from the comparison mode to the performance mode, there is no need for H280a, H280b, since no synchronization is required.

The proposal described here presupposes a unit (designated ID unit) or method which enable each execution unit to ascertain its individual number or unit ID. In a system having two execution units, for example, one execution unit is able to ascertain number 0 for itself, and the other number 1 for itself. In a system having more than two execution units, the numbers are assigned and, respectively, ascertained correspondingly. This ID does not make the distinction between a comparison mode and a performance mode, but denotes an execution unit invectively. The ID unit may be included in the respective execution units, implemented, for example, as a bit or bit combination in the processor status register or as a register of its own, or as a single bit or as a unit that is external to the execution units and that delivers the appropriate ID when queried.

Once the execution units have made the switch to the performance mode in accordance with a switchover request, the comparison unit is, in fact, no longer active, but the execution units still execute the same instructions. This is due to the fact that the instruction indicators, which indicate the place in the program where an execution operation will be performed in the next step or is currently being performed, are not influenced by the switchover operation. To enable the execution units to subsequently execute different SW modules, it is necessary to separate the program flow of the execution units. Therefore, depending on the circumstances, the instruction indicators typically have different values in the performance mode, since independent instructions, program segments or programs are, in fact, processed in accordance with the exemplary embodiments and/or exemplary methods of the present invention. In the proposal described here, the program flows are separated by ascertaining the particular execution unit number. Depending on the ID possessed by an execution unit, the execution unit executes a specific software module. Since each execution unit has an individual number or ID, this may be used to reliably separate the program flow of the participating execution units.

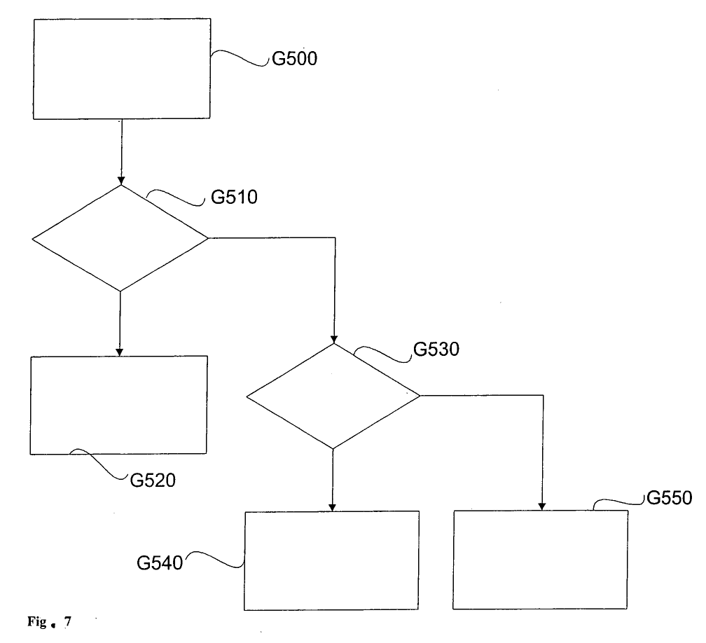

A flow chart in FIG. 7 shows a method illustrating how, with the aid of the unit IDs, the program flow is able to be separated when the switch is made from a comparison mode to a performance mode in a multiprocessor system having two execution units. Once the switch is made from a comparison mode to a performance mode G500, the two execution units query the unit IDs or execution unit number G510. In this context, in accordance with the exemplary embodiments and/or exemplary methods of the present invention, execution unit 0 receives execution unit number 0, and execution unit 1 receives execution unit number 1. In G510, the ascertained execution unit number is compared to number 0. If they are the same, that execution unit, for which this comparison was successful, continues in step G520, using the code for execution unit 0. The execution unit, for which this comparison was not successful, continues the process of making a comparison to number 1 in G530. If this comparison is successful, the process is continued, using the code for execution unit 1 in G540. If this comparison is not successful, then an execution unit number unequal to 0 and 1 is thus ascertained for the execution unit in question. This constitutes a fault case, and the process continues at G550.

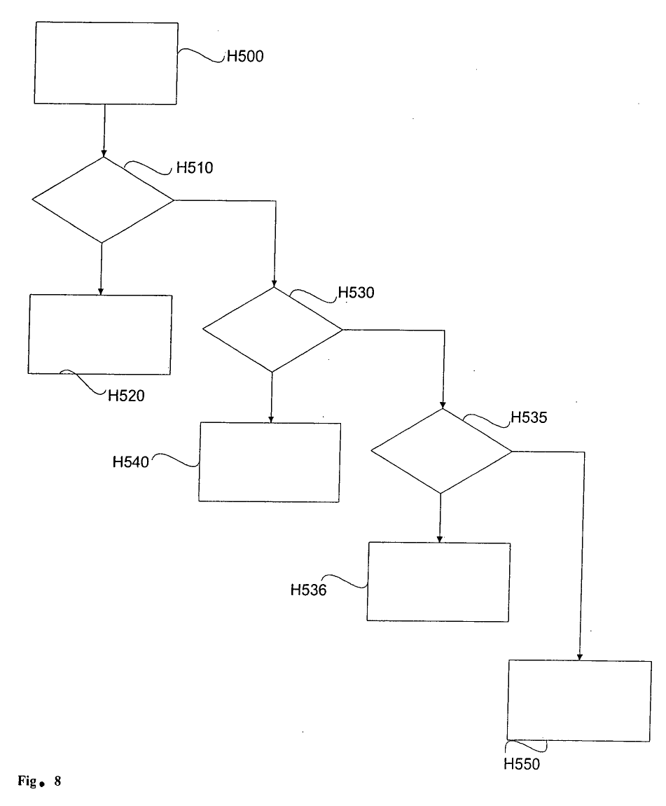

One possible method for three execution units is illustrated in FIG. 8. Once the switch is made from a comparison to a performance mode H500, the execution units query the unit ID or execution unit number G510. In this context, in accordance with the exemplary embodiments and/or exemplary methods of the present invention, for example, execution unit 0 receives execution unit number 0, execution unit 1 execution unit number 1, and execution unit 2 execution unit number 2. In H510, the ascertained execution unit number is compared to number 0. If they are the same, that execution unit, for which this comparison was successful, continues in step H520, using the code for execution unit 0. The execution units, for which this comparison was not successful, continue the process of making a comparison to number 1 in H530. In the execution unit for which this comparison is successful, the process is continued using the code for execution unit 1 in H540. The execution units, for which this comparison was not successful, continue the process of making a comparison to number 2 in H535. The execution unit, for which this comparison is successful, is continued using the code for execution unit 2 in H536. If this comparison is not successful, then an execution unit number unequal to 0.1 and 2 is thus ascertained for the execution unit in question. This constitutes a fault case, and the process continues at H550. Alternatively to the process of comparing to a number, the ascertained execution unit number may able be used directly as an index to a branch table.

According to this description, this method may also be used for multiprocessor systems having more than three execution units.

Several considerations are involved when the switch is made from the performance mode to the comparison mode. When the switch is made from the performance mode to the comparison mode, it must be ensured that the internal states of the execution units are substantially identical following the switchover operation, otherwise a fault could possibly be detected in the comparison mode if the different starting conditions were to lead to different outputs. This may be implemented by hardware, software, firmware or by a combination of all three. The requirement is that all execution units execute the same or similar instructions, programs or program segments once the switch is made to the comparison mode. In addition, a synchronization method is described which may be applied when it is a feature of the comparison mode that identical instructions are processed and that a bit-precise comparison takes place.

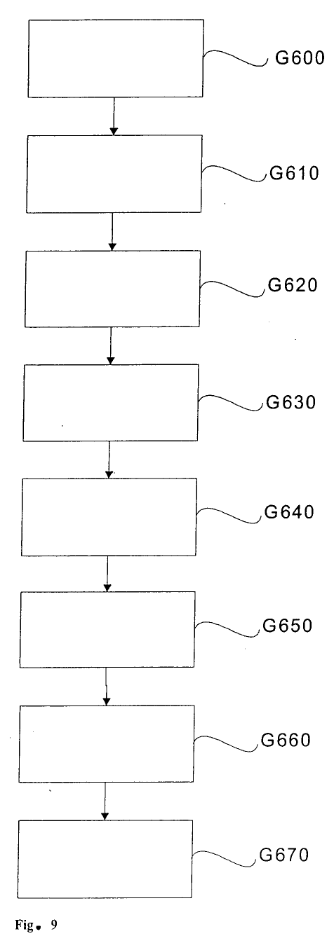

In a flow chart, FIG. 9 illustrates a method which synchronizes the execution units when the switch is made from a performance mode to a comparison mode. All interrupts may be blocked in step G600. This is important, not only because it is necessary to reprogram the interrupt controller accordingly for the comparison mode. It is also intended for an internal state alignment of the execution units to be implemented by software. If, however, an interrupt is triggered during the process of preparing to switch to the comparison mode, then an alignment that does not entail additional outlay is no longer possible.

Step G610: If the two execution units have separate caches, then it is necessary to align the cache contents before the switchover operation to ensure that, in the comparison mode for one address, a cache hit is not obtained for one execution unit, while a cache miss is obtained for another execution unit. If this is not implemented independently by the cache hardware, it is to be effected, for example, by marking all cache lines as invalid. The process must wait until the cache (or caches) are completely invalid. If needed, this is to be ensured by a wait loop in the program code. This may also be achieved by other ways; what is decisive is that the caches be in the same state following this step.

The write buffers of the execution units are emptied in step G620, so that, once the switchover operation is performed, no execution unit activities take place that are still attributable to the performance mode.

The state of the pipeline stages of the execution units is synchronized in step G630. For this purpose, one executes, for example, an appropriate number of NOP (no operation) instructions before the switchover sequence/switchover instruction. The number of NOP instructions conforms to the number of pipeline stages, and is thus a function of the particular architecture. Likewise dependent on the architecture is which instruction is suited as an NOP instruction. If the execution units have an instruction cache, then it must be ensured in the process that this instruction sequence be aligned on the boundaries of a cache line. Since the instruction cache has been marked invalid prior to execution of these NOPs, these NOPs must first be loaded into the cache. If this instruction sequence begins at a cache line boundary, then the data transfer from the memory (e.g., RAM/ROM/flash) to the cache is terminated before the switchover instruction is carried out. This must also be included in the consideration when determining the required number of NOPs.

The instruction step for switching to the comparison mode is actually carried out in step G640.

In step G650, the contents of the particular register files is aligned with each execution unit. To this end, the registers need to be loaded with identical contents before or after the switchover operation. In this connection, following the switchover operation, it is important that the contents of a register in the execution units be identical before the register contents is transferred to external locations and consequently compared by the comparison unit.

In step G660, the interrupt controllers are reprogrammed, so that an external interrupt signal triggers the same interrupt in all of the interconnected execution units.

The interrupts are released again in step G670.

If it is not clear from the program sequence when the switch to the comparison mode is to be made, then it is necessary that the participating execution units be informed about the planned switchover operation. To this end, an interrupt may be initiated in the interrupt controllers associated with the particular execution units, e.g. an interrupt is initiated per SW. The interrupt handling then prompts execution of the above-described interconnection sequence.

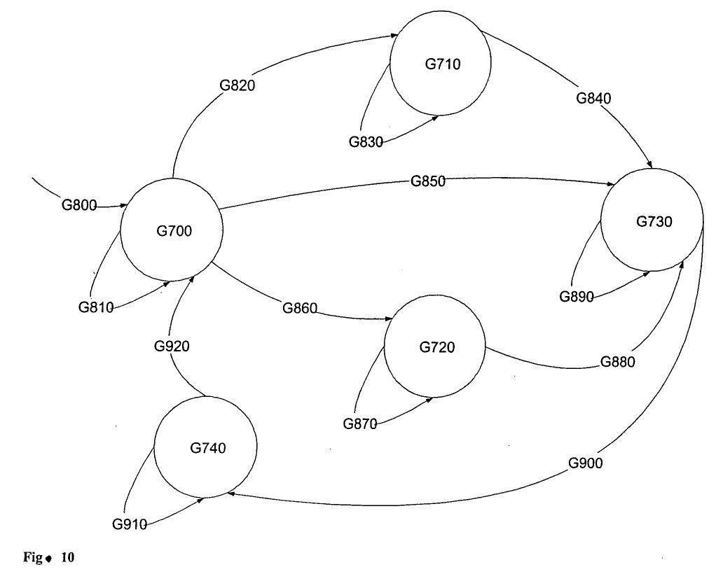

FIG. 10 shows a finite automaton, which represents the switch between a performance and a comparison mode (and vice versa). At system start-up, in response to “power on” or even reset (software or hardware), the system is placed in state G700 via transition G800. Typically, following an undefined event that may trigger a reset, the system always begins operation in state G700. Examples of events that may trigger a reset include external signals, problems in the voltage supply or internal fault events which make continued operation impractical. Thus, state G700 of switchover and comparison unit G70 and also of multiprocessor system G60, in which the operation is carried out in the performance mode, is the default state of the system. In all cases in which an otherwise undefined state would be assumed, default state G700 is assumed. In this context, this default setting of state G700 is ensured by hardware measures. The system state or the state of switchover and comparison unit G60 may be encoded, for example, in a register, in a bit in a register, by a bit combination in a register, or by a flip-flop.

It is then ensured by hardware that state G700 is always assumed after a reset or power on. This is ensured, for example, in that the reset signal or the “power on” signal is transmitted to the reset input or to the set input of the flip-flop or of the register.

In state G700, the system operates in a performance mode. Thus, execution units G10a, G10b process different instructions, programs or basic blocks. A switchover request may be recognized, for instance, by execution of a special switchover instruction by an execution unit G10a, G10b. It may also be recognized by the access to a special memory address, by an internal signal or even by an external signal. Multiprocessor system G60, and thus also switchover and comparison unit G70 remain in state G700 for as long as no switchover request is present. In the subsequent operation, the switchover request signifies recognition of a switchover condition that is characterized by a switchover request in this special system.

A continuation in state G700 is represented by transition G810. In response to detection of a switchover request by execution unit G10a, switchover and comparison unit G70 goes over to state G710 via transition G820. Thus, state G710 connotes that execution unit G10a has detected a switchover request and is waiting until execution unit G10b has likewise detected a switchover request. For as long as long as this does not occur, switchover and comparison unit G70 remains in state G710, which is represented by transition G830.

Transition G840 takes place when, in state G710, execution unit G10b likewise recognizes a switchover request. Switchover and comparison unit G70 consequently assumes state G730. This state connotes that both execution units G10a, G10b have recognized a switchover request. The synchronization process, which is used to mutually synchronize the two execution units G10a, G10b to enable them to subsequently operate in the comparison mode, takes place in state G730. During this process, switchover and comparison unit G70 remains in state G730, as is represented by transition G890.

If a switchover request is first recognized by execution unit G10b in state G700, then the switch is made via transition G860 to state G720. Thus, state G720 connotes that execution unit G10b has detected a switchover request and is waiting until execution unit G10a has likewise detected a switchover request. For as long as long as this does not occur, switchover and comparison unit G70 remains in state G720, which is represented by transition G870. Transition G880 takes place when, in state G720, execution unit G10a likewise recognizes a switchover request. Thus, the switchover and comparison unit assumes state G730.

If both execution units G10a, G10b simultaneously recognize a switchover request in state G700, then the transition to state G730 is made immediately. This case is represented by transition G850.

When switchover and comparison unit G70 is in state G730, both execution units G10a, G10b have recognized a switchover request. In this state, the internal states of execution units G10a, G10b are synchronized to enable operation in the comparison mode, once these synchronization processes are complete. Transition G900 takes place once these synchronization tasks are complete. This transition indicates the end of the synchronization process. In state G740, execution units G10a, G10b operate in the comparison mode. The completion of the synchronization operations may be signaled by execution units G10a, G10b themselves. This means that transition G900 takes place when both execution units G10a, G10b have signaled that they are ready to operate in the comparison mode. The completion may also be signaled by a preset, fixed time. This means that the length of time the system is to remain in state G730 is permanently encoded in switchover and comparison unit G70. This time is set in a way that ensures that both execution units G10a, G10b have definitely completed their synchronization tasks. Once this time has elapsed, transition G900 is then initiated. In another variant, switchover and comparison unit G70 may monitor the states of execution units G10a, G10b and detect, on its own, when both execution units G10a, G10b have completed their synchronization operations. Once the detection has been made, transition G900 is then initiated.

For as long as no switchover request is detected, multiprocessor system G60 remains in the comparison mode, as represented by transition G910. When a switchover request is recognized in state G740, the switchover and comparison unit is placed in state G700 via transition G920. As previously described, in state G700, the system operates in the performance mode. The program flows may then be separated in response to the transition from state G740 to state G700, as in the method described.

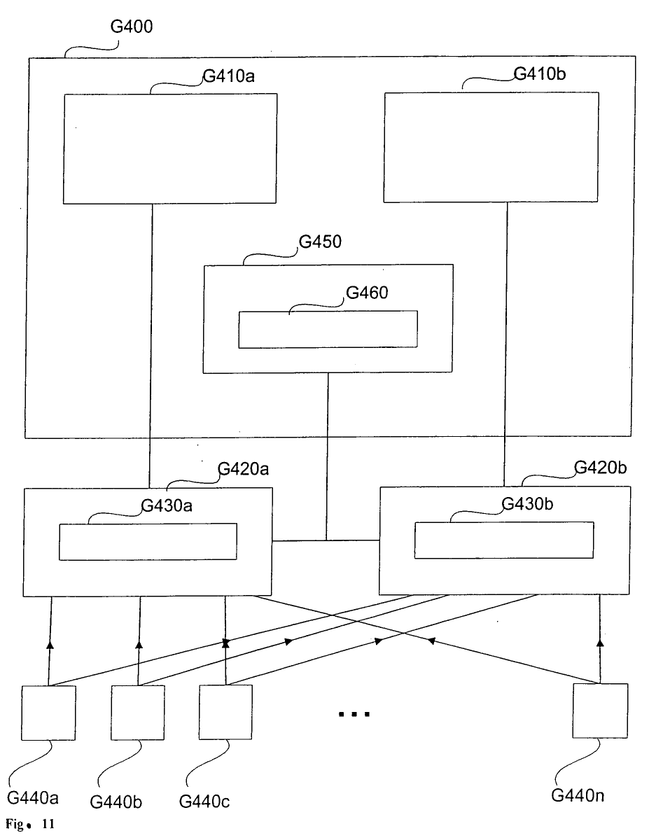

FIG. 11 shows a multiprocessor system G400 having two execution units G410a, G410b, as well as two interrupt controllers G420a, G420b, including interrupt masking registers G430a, G430b contained therein, and various interrupt sources G440a through G440n. Also shown is a switchover and comparison unit G450 having a special interrupt masking register G460.

Each execution unit G410a, G410b advantageously possesses its own interrupt controller G420a, G420b, in order to be able to handle two interrupts simultaneously in the performance mode. This is especially beneficial in systems in which the interrupt handling constitutes a bottleneck in the system performance. In this context, interrupt sources G440a through G440n are advantageously directly connected to both interrupt controllers G420a, G420b, respectively. The effect of this type of connection is that, without applying any additional measures, the same interrupt is triggered on both execution units G410a, G410b. In the performance mode, interrupt controllers G420a, G420b are programmed to permit interrupt sources G440a through G440n in question to be suitably distributed over the different execution units G410a, G410b, as a function of the particular application. This is accomplished by suitably programming of interrupt masking registers G430a, G430b. For each interrupt source G440a through G440n, the masking registers provide one bit in the register. If this bit has been set, the interrupt is blocked; i.e., it is not routed to the connected execution unit G410a, G410b. A given interrupt source G440a through G440n is advantageously processed by exactly one execution unit G410a or G410b in one performance mode. This advantageously applies to at least some of the interrupt sources. This enables a plurality of interrupt sources G440a through G440n to be processed simultaneously without the occurrence of any interrupt nesting (an interrupt processing is interrupted by a second interrupt) or interrupt pending (the processing of the second is delayed until the processing of the first is complete).

In the comparison mode, it must be ensured that interrupt controllers G420a, G420b trigger the same interrupt simultaneously on all execution units G410a, G410b; otherwise a fault would be detected in accordance with a comparison mode. This means that, in the synchronization phase, when the switch is made from the performance mode to the comparison mode, it must be ensured that interrupt masking registers G430a, G430b are identical. This synchronization is described in FIG. 9, in step G660. This synchronization may be carried out by software, in that both interrupt masking registers G430a, G430b are programmed accordingly, using the same value. It is proposed that a special register G460 be used, in order to accelerate the switching operation. In one specific embodiment, this register G460 is located in switchover and comparison unit G450, however, it may also be included in switchover request detection G40, in a combined switchover request detection, in the comparator, in switchover unit G80, as well as in all combinations thereof. It is also conceivable that this register be located outside of these three components, at another suitable location. Register G460 includes the interrupt masking intended for the comparison mode. Switchover and comparison unit G450 receives a signal from switchover request detection G40 for switching from a performance mode to a comparison mode. Once the interrupts are able to be blocked in step G600, interrupt masking registers G430a, G430b of interrupt controllers G420a, G420b are reprogrammed. This is implemented as a hardware function, by switchover and comparison unit G450, in parallel with the remaining synchronization steps, once the switchover signal has been received and interrupt controllers G420a, G420b have been blocked. Interrupt masking registers G430a, G430b are not individually reprogrammed in the comparison mode; instead it is always central register G460 that is reprogrammed. This is then transmitted synchronously by hardware to the two interrupt masking registers G430a, G430b. The method, which is described here in terms of an interrupt masking register, may be similarly applied to all interrupt status registers that are located in an interrupt controller. In place of a register G460, it is, of course, also conceivable to use a different storage medium, from which a transmission to interrupt masking registers G430a, G430b may be carried out as rapidly as possible.

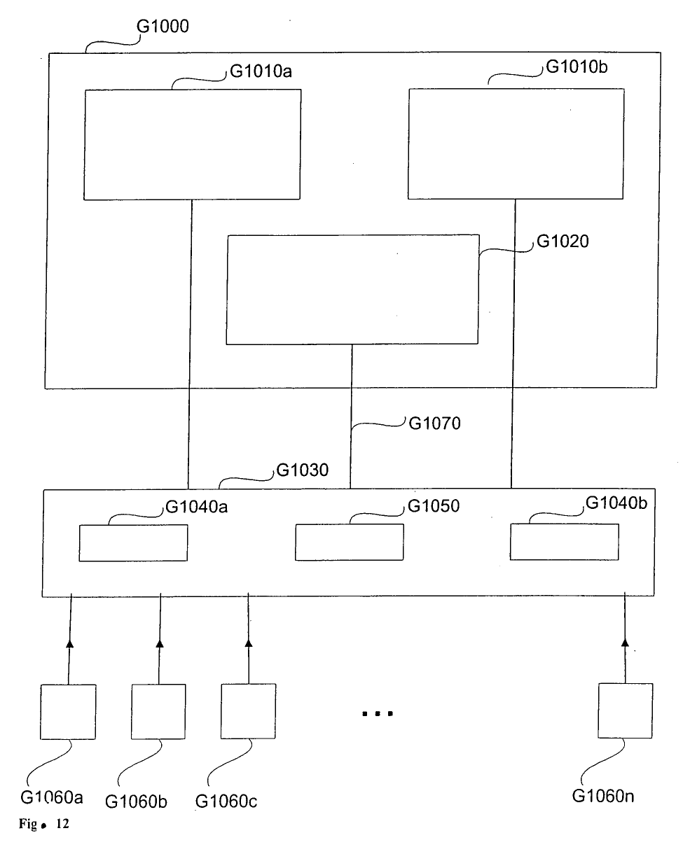

FIG. 12 shows a proposed multiprocessor system G1000 having two execution units G1010a, G1010b, one switchover and comparison unit G1020, as well as one interrupt controller G1030 including three different register records G1040a, G1040b, G1050. As an alternative to the approach described above, a special interrupt controller G1030 is proposed, as shown in FIG. 12. This is employed in a multiprocessor system G1000, which is illustrated in the example as having two execution units G1010a, G1010b, as well as one switchover and comparison unit G1020, which is able to switch between a comparison and a performance mode.

In this context, register records G1040a, G1040b are used in the performance mode. In this case, the operation of interrupt controller G1030 is precisely the same as that of the two interrupt controllers G420a, G420b. These performance characteristics are illustrated and described in FIG. 11. In the process, register record G1040a is assigned to execution unit G1010a, and register record G1040b to execution unit G1010b. Interrupt sources G1060a through G1060n are suitably distributed per masking over execution units G1010a, G1010b. When the switch is made from a performance mode to a comparison mode, switchover and comparison unit G1020 generates a signal G1070. This signals to interrupt controller G1030 that the switch is made to the comparison mode or that the system is operating in the comparison mode from this point in time on. Accordingly, interrupt controller G1030 uses register record G1050. This ensures that the same interrupt signals are produced at both execution units G1010a, G1010b. By changing from the comparison mode to the performance mode, which is again signaled by switchover and comparison unit G1020 via signal G1070 to interrupt controller G1030, the switch is again made to register records G1040a, G1040b. Thus, a protection of the register records in question may also be advantageously accomplished, in that, in the performance mode, only a writing to register records G1040a, G1040b is permitted, and a writing to register record G1050, which is reserved for the comparison mode, is prevented by hardware. Conversely, in the comparison mode, only a writing to register record G1050 is permitted, and a writing to register records G1040a, G1040b is prevented.

FIG. 13 shows the simplest form of a comparator M500, G20. An important component in a multiprocessor system G60 having at least two execution units G10a, G10b including a switchover capability between a performance mode and a comparison mode is comparator M500. It is shown in its simplest form in FIG. 13. Comparison component M500 is able to receive two input signals M510 and M511. It then compares them to check for parity, in the context described here, which may be in the sense of a bit parity. In the case of parity, the value of input signals M510, M511 is applied to output signal M520, and error signal M530 does not become active, i.e., it signals the “good” state. If it detects disparity, error signal M530 is activated. Signal M520 may then be optionally deactivated. This has the advantage that the fault does not make it out of the system in question (“fault containment”). This means that other components, located outside of the execution units, are not corrupted by the potentially faulty signal. However, there are also systems in which signal M520 does not have to be deactivated. This is the case, for example, when, at the system level, only fail silence is required. The error signal may then be routed to the outside, for example.

Using this basic system as a point of departure, a multiplicity of specific embodiments is conceivable. To begin with, component M500 may be designed as a so-called TSC component (totally self checking). In this case, error signal M530 is routed to the outside via at least two lines (“dual rail”). Also, internal design and fault detection measures ensure that, in every possible case involving fault of the comparison component, this signal is present in a correct or identifiably incorrect form. In the process, a binary signal is provided by a dual rail signal via two lines, which may be in such a way that the two lines are mutually inverted in the error-free case. With regard to utilization of the system according to the exemplary embodiments and/or exemplary methods of the present invention, one variant provides for such a TSC comparator to be employed.

A second class of specific embodiments is distinguished by the degree of synchronism required of the two inputs M510, M511 (or M610, M611). One possible specific embodiment is characterized by clocked synchronism, that is, the data comparison process may be carried out in a clock pulse cycle.

A slight modification is necessitated by a fixed phase shift between the inputs, in that a synchronous delay element is used which delays the signals in question, for example, by half-integer or integer clock-pulse periods. Such a phase shift is useful in order to avoid common cause faults, that is, those fault causes capable of influencing a plurality of processing units simultaneously and in a substantially similar manner.

Therefore, FIG. 14 illustrates another specific embodiment. Components and signals M600, M610, M611, M620, M630 in FIG. 14 are equivalent to the corresponding components and signals M500, M510, M511, M520, M530 in FIG. 13. Therefore, component M640, which delays the earlier input by the phase shift, is additionally introduced in FIG. 14. This delay element may be accommodated in the comparator, in order for it to be used only in the comparison mode. Alternatively or additionally, intermediate buffers M650, M651 may be placed in the input chain, in order to be able to likewise tolerate such asynchronisms, which are not manifested as a pure clock-pulse shift or phase shift. These intermediate buffers may be provided as FIFO memories (first-in, first-out). Such a memory has an input and an output and is able to store a plurality of memory words. An incoming memory word is shifted in its position in response to the arrival of a new memory word. Following the last position (the depth of the buffer), it is shifted “out of the memory.” If such a buffer is present, asynchronisms up to the maximum depth of the buffer may also be tolerated. In such a case, an error signal must also be output when the buffer overflows.

Moreover, in the comparator, one may distinguish among specific embodiments by the manner in which signal M520 (or M620) is generated. One specific embodiment provides for applying input signals M510, M511 (or M610, M611) to the output and to make the connection interruptible by switches. This specific embodiment has the special advantage that the same switches may be used for switching between the performance mode and different possible comparison modes. Alternatively, the signals may also be generated from intermediate buffers internal to the comparator.

One last class of specific embodiments may be distinguished by how many inputs are present at the comparator and by how the comparator is to react. In the case of three inputs, a majority voting, a comparison of all three, or a comparison of only two signals may be undertaken. In the case of four or more inputs, correspondingly more specific embodiments are conceivable. A detailed description of the possible specific embodiments is included in the description of FIG. 20.

The exact selection of the specific embodiments may be coupled to the various operating modes of the overall system. This means that when there are a plurality of different performance or comparison modes, then these may be coupled to the corresponding mode of the comparator.

There are instances along the line of the exemplary embodiments and/or exemplary methods of the present invention where it is necessary or beneficial to deactivate or render passive a comparator or a more general voting/processing/sorting element (for the sake of simplicity, always denoted in the following as comparator). There are many ways to effect this. First of all, a signal may be transmitted to the comparator, to activate or deactivate the same. To this end, an additional logic capable of effecting this is to be added to the comparator. Another option provides for not supplying any data for comparison to the comparator. A third option provides for ignoring the error signal of the comparator at the system level. In addition, the error signal itself may also be interrupted. Common to all of the options is that, in the system, it is irrelevant that two or more data to be potentially compared, are different. If this is the case, the comparator is considered to be passive or deactivated.

The following considers an implementation of a change-over switch in conjunction with a comparator, thus a switchover and comparison unit G70. This implementation is particularly beneficial in the case that it is designed, together with execution units G10a, G10b, inside of a chip.

Combining the comparator and change-over switch components produces only very minimal hardware overhead in an implementation within a chip. Therefore, one variant of the implementation provides for combining these two parts in one component. This is a component having at least the input signals (output execution unit 1, output execution unit 2), at least the output signals (output 1, output 2), a logical output signal “total output” (may be physically equivalent to output 1 or output 2) and a comparator. The component has the capability of switching the mode, of allowing passage of all signals in the performance mode, and of comparing a plurality of signals in a comparison mode and, if indicated, to allow passage of one. In addition, other input and output signals are advantageous: An error signal for signaling a detected fault, a mode signal for signaling the mode in which the particular component is at the moment, and control signals from and to the component.

In one exemplary embodiment, the two or more execution units are connected in the performance mode as a master to a bus internal to the processor. The comparison unit is deactivated, or the error signal, which is generated in response to different performance characteristics of the execution units, is masked in one of the conceivable comparison modes. This means that the switchover and comparison unit is transparent to the software. In the comparison mode under consideration, the physical execution units to be compared are treated as one logical execution unit at the bus, that is, only one master appears at the bus. The error signal of the comparator is activated. To that end, via switches, the switchover and comparison unit separates all but one execution unit from the processor-internal bus, duplicates the inputs of the one logical execution unit, and makes these available to all of the execution units participating in the comparison mode. During the process of writing to the bus, the outputs are compared in the comparison unit and, if there is parity, these data are written to the bus via the one available access.

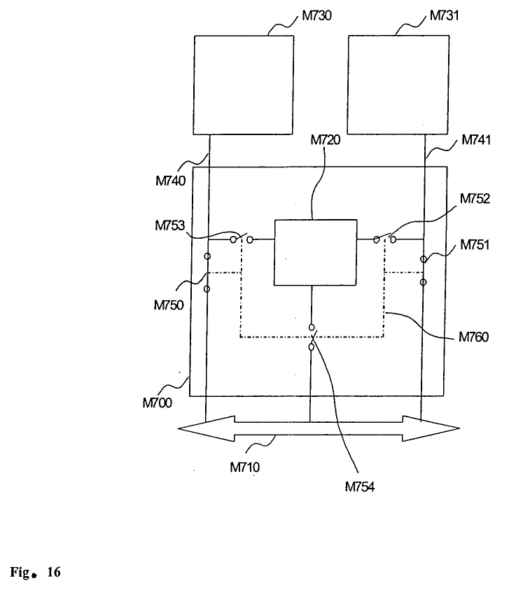

FIGS. 15 and 16 illustrate the fundamental performance characteristics of a component M700 (switchover and comparison unit, corresponds to G70). For the sake of simplicity, this figure has been sketched with reference to only two execution units. In this context, FIG. 15 shows the status of the component in the comparison mode; FIG. 16 in the performance mode. The various switch settings in these modes are implemented by M700 through control M760. The two execution units M730, M731 may, first of all, write in the performance mode to data bus and address bus M710 when switches M750 and M751 are closed, as shown in FIG. 16. It is assumed that potential writing conflicts are resolved, either via the bus protocol or by other components (not shown). In the comparison mode, the performance characteristics are different, at least from a logical point of view. As shown in FIG. 15, switches M750, M751 are then open, so that the direct access possibilities are interrupted. In contrast to FIG. 16, in FIG. 15, switches M752, M753 are then closed, however. Signals M740, M741 of execution units M730, M731 are routed to comparison component M720. This is at least designed as shown in FIG. 13, however, it may also include expansions as shown in FIG. 14. However, a description of the error signal or also of other signals of comparison component M720 is omitted in FIGS. 15 and 16. If the two signals conform, switch M754 is closed, and one of the two conforming signals is then transmitted to address/data bus M710. Overall therefore, this requires that switchover and comparison unit M700 be able to influence switches M750-M754. The particular switch setting is dependent on the mode and on the fault detection. This also includes variants which provide for switch M754 to always be closed and for an appropriate system reaction to be generated by the error signal.

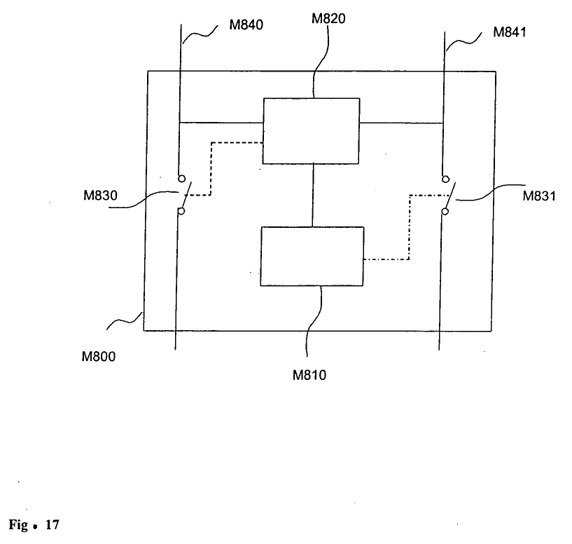

A variant of the switchover and comparison unit is shown in FIG. 17. Even for a simple system having only two execution units G10a, G10b, many variants exist for implementing a switchover and comparison unit. Another variant that is particularly advantageous when no buffers are to be used in the comparator, is shown in FIG. 17. As in FIGS. 15 and 16, there are signals M840, M841 of the execution units. The latter are not shown in this figure. Component M800 according to the exemplary embodiments and/or exemplary methods of the present invention includes a mode logic M810 which specifies the mode of the component. In the performance mode, it closes switch M831 and, in the comparison mode, it opens it. In addition, it transmits the mode signal to comparator M820. In this implementation, this comparator always carries out the comparison, but uses the comparison result and the mode signal to control switch M830. In the performance mode, the switch is always closed; in the comparison mode, always when no fault is at hand. Of course, once a fault is ascertained, the switch may remain open until a suitable reset is carried out.

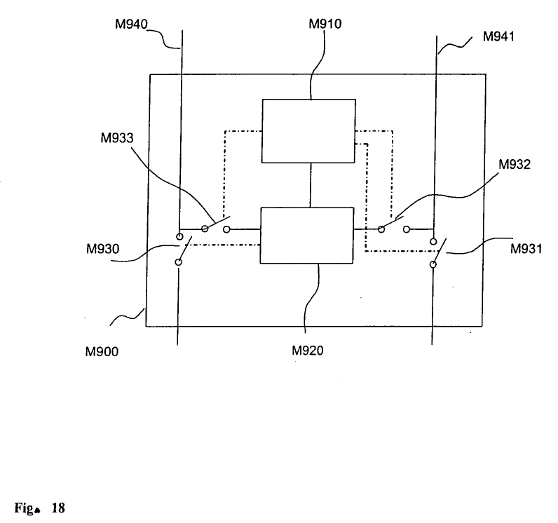

FIG. 18 shows another specific embodiment of the switchover and comparison unit. This alternative does, in fact, provide for more switches, but, as a result, it leaves the comparator inactive in the performance mode and, for that reason, is able to better handle asynchronisms. Again, there are the two signals M940, M941 of the execution units. The latter are again not shown in this figure. Component M900 according to the exemplary embodiments and/or exemplary methods of the present invention is provided with a mode logic M910 which specifies the mode of the component. In the performance mode, it closes switch M931 and opens switches M932, M933. Thus, in this mode, data are not sent to comparison component M920. In the case of asynchronisms, this allows longer buffer times, respectively, in an implementation, lower buffer depths. In the performance mode, switch M930 is always closed. In the comparison mode, component M910 closes switches M932, M933 and interrupts the direct access to the bus by opening switch M931. Optionally, mode logic M910 may still inform comparator M920 of the mode. In the error-free case, switch M930 is closed in the comparison mode. In the case of an error, comparison component M920 interrupts the transmission of signal M940 to the bus by opening switch M930.

In the described drawings, the mode signals or the error signals may be readily routed to the outside. In addition, additional signals may be readily transmitted to the component, in particular to generate the internal mode state.

In summary, an exemplary implementation of this component is thus characterized by the provision of a plurality of processing units which are able to write output signals to the bus (e.g. address/data bus). What is important is that the component be able to process at least two of the output signals of the execution units (e.g., by comparing, but possibly also voting or sorting the same), and that the component be able to influence at least one switch which is used to interrupt at least one of the direct bus accesses. This is particularly useful when the execution units are processor cores. It is also advantageous when the state of the influenceable switches characterizes the operating mode of the processing unit.

The system properties, in particular the possible comparison modes, are implemented especially effectively when the component is able to apply a signal to the address data bus. This advantageously constitutes a through connection of one of the output signals from one of the execution units.

Alternatively, this may result from the processing of different output signals from the various execution units.

As was already made apparent in the descriptions relating to FIGS. 17 and 18, mode information may be identified in the system and, depending on the allocation to the components, in one of the components as well. Depending on the implementation, this mode information may even be explicitly present in a subcomponent. In one implementation, this signal may also transmitted out of the component and be made available to other parts of the system.

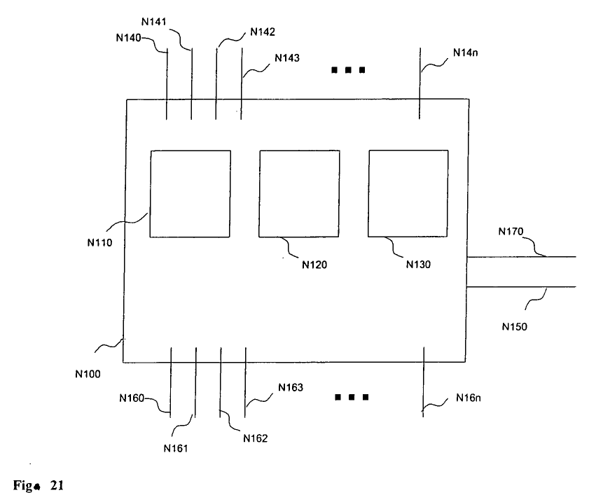

The performance characteristics according to the exemplary embodiments and/or exemplary methods of the present invention may typically be explained with reference to FIG. 21. Signals and components N100, N110, N120, N130, N140, N141, N142, N143, N14n, N160, N161, N162, N163, N16n are equivalent to those in FIG. 20. Moreover, mode signal N150 and error signal N170 are sketched in this figure. The optional error signal is generated by fault switching logic N130, which collects the error signals, and is either a direct further routing of the individual error signals or a bundling of the fault information contained therein. Mode signal N150 is optional; its use outside of this component may, however, be advantageous at many locations. The combination of the information of switching logic N110 (i.e., the function named in the description of FIG. 20) and of the processing logic (i.e., the establishment of the comparative operation per output signal, that is per functional value) is the mode information, and this determines the mode. Generally, this information is naturally multi-valued, i.e., not representable by only one logic bit. Not all theoretically conceivable modes are practical in a given implementation; one may limit the number of permitted modes. The mode signal then brings the relevant mode information to the outside. An HW implementation may be presented in such a way that the externally visible mode signal is able to be configured. The processing logic and the switching logic may be likewise arranged to be configurable. These configurations may be matched to one another. Alternatively, one may also only or additionally transmit changes in the mode signal to the outside. This especially has advantages in a base-two configuration.

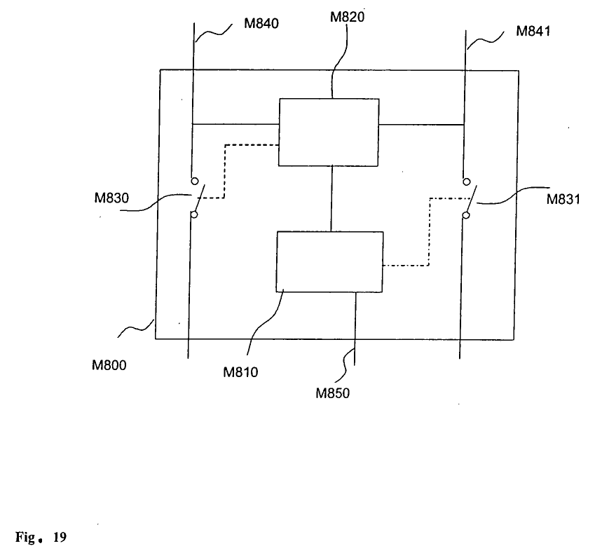

This mode signal may be protected. An implementation in the base-two system based on the implementation shown in FIG. 17, for example, is shown in FIG. 19. There, signal M850 is transmitted out of the switchover and comparison unit. In a base-two system, this information is logically presentable via one bit. Protection may then be implemented via a dual-rail signal. Typically, the signal may likewise be protected by a duplication that is optionally inverted. Alternatively, a parity may also be generated that may be internally generated in a self-protecting manner, or a CRC (cyclic redundancy check) or an ECC (error correcting code) may be used.

The mode signal may be employed outside of the component. It may first be used for self-monitoring of the operating system. From an SW point of view, this is responsible for a switchover operation, and should always know the mode the system is currently in, and also bring the system into this mode. This signal may be checked for protection purposes. This may initially be accomplished directly. Alternatively, however, timers or other “independent” units may be used to validate a query of the operating system by this signal.

Typically, this signal may optionally be used in other data sinks of a μC (or more general processing unit) as well. For example, an MPU (memory protection unit) may be programmed to permit specific memory accesses (from specific execution units) only in specific modes. In this context, an MPU is a unit which is able to ensure that only admissible accesses are made to the data/address bus, for instance, by preventing access to certain memory address spaces for certain program parts. By bringing the mode signal to the MPU, by suitably configuring and programming this MPU, and by evaluating these configuration data and the mode signal, an additional protection is able to be provided. Under certain circumstances, this even simplifies the programming, in the case that the mode signal already constitutes sufficient information for checking purposes. A quasi-static programming at the initialization time of the μC then suffices. This may apply correspondingly to peripheral units. Here as well, there are applications in which access to a corresponding peripheral element is only permitted in certain modes. By bringing the mode signal to the peripheral element, properly configuring and programming the peripheral element, and by evaluating these configuration data and the mode signal, an additional protection may be provided. Under certain circumstances, this even simplifies the programming, in the case that the mode signal already constitutes sufficient information for checking purposes. A quasi-static programming at the initialization time of the μC then suffices. Analogously, the evaluation of this signal may also be used at the interrupt controller. Such monitoring may then form the basis or make up an essential component of the security concept. Through proper execution and SW structuring, it may be possible to devise the security concept for an entire fault class in the application under consideration for this mode signal. This is especially advantageous when the mode signal is self-protecting in a suitable form, as described above. In such a case, a further advantage is derived when the component under consideration is capable of transmitting an error signal or of activating a disabling path, if it detects a discrepancy between the mode signal and the access to itself.

Another important intended application pertains to analysis of the mode signal outside of the processing unit. A direct application is the analysis in a decrementing watchdog. Such a “watchdog” is constituted of at least one (counter) register, which may be set to an integer value by the microprocessor. Once this register is set, the watchdog independently decrements the value of the register by a fixed period. If the value of the register is zero, or if an overflow occurs, the watchdog generates an error signal. If it is not intended for the error signal to be generated, then the microprocessor must reset the value of the register in a timely manner. This allows a check to be made (within limits) as to whether the microprocessor is correctly executing the software. If the microprocessor is no longer executing the software correctly, it is assumed in this case that the watchdog is also no longer being operated correctly, and an error signal is thus generated by the watchdog. The integrity of the hardware and the data structures may be reliably checked in a comparison mode. To this end, it must be ensured, however, that the microprocessor is regularly switching back to this mode. Therefore, the task of the watchdog described here is not only to generate an error signal when it is no longer reset within a defined time period, but also when the microprocessor no longer switches back to the defined comparison mode within a defined time period. For example, the watchdog may only be reset when the mode signal indicates the defined comparison mode of the processing unit. This ensures that the processing unit is regularly switching back to this mode. Alternatively or additionally, the value in the register of the watchdog is only decremented when specific interrupts are triggered in the microprocessor. To this end, the external interrupt signals of the μC must be coupled to the watchdog as well. The information on those interrupts which switch the μC to the specified comparison mode is stored in the watchdog. The watchdog is “wound up” as soon as such an interrupt arrives; it is reset by the presence of the correct mode signal.

It is generally useful, particularly in an application for a security concept, to evaluate the mode signal in a μC-external source. An important point to consider in protecting the correct operational sequence of the software on a computer, as described for the exemplary embodiments and/or exemplary methods of the present invention, is making the correct changes among the various permitted modes. It is first necessary to check the capacity to change itself, and this may be done for the correct changing process as well. As described above, it is also of interest that a special mode is regularly assumed. Such a method is always particularly advantageous when the mode signal itself is conceived as a self-protecting signal. One option is to direct the mode signal to an ASIC or to another μC. Using timers and simple logic, this is able to check at least the following points, employing this signal:

Does the processing unit come often enough (at the latest, for example, every 1000 μs) into one or a plurality of defined modes?

Is one specific signal always emitted in response to a change to a mode?

Does the processing unit regularly leave a mode?

Are certain simple patterns of the sequence of the modes valid?

Is a general time pattern valid (for example, on average <70% in mode 1 and <50% in mode 2)?

Any combination of logic properties, time properties of the mode signal, optionally supplemented by the use of additional signals.

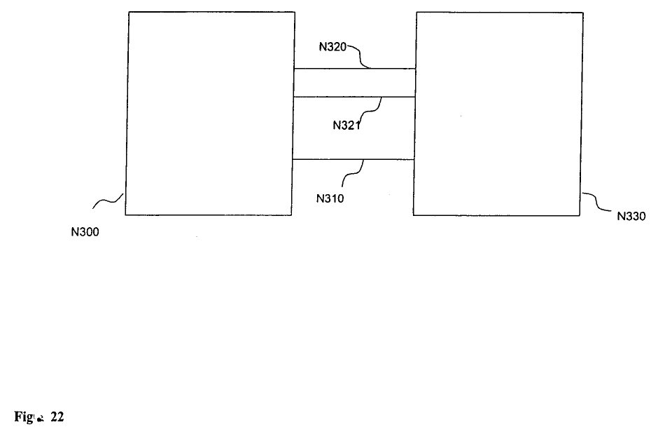

In this context, FIG. 22 illustrates the basic configuration for a proposal going beyond all this in that a special query and reply cycle is carried out between such a partner ASIC or partner μC and the processing unit under consideration having the features in accordance with the exemplary embodiments and/or exemplary methods of the present invention. N300 is a processing unit that is able to emit such a mode signal. This may be a μC, for example, having a plurality of execution units and another component capable of generating this mode signal. For example, this other component may be implemented, as shown in FIG. 19 or 21. N300 transmits this signal N310 to the partner (e.g., another processing unit, another μC or ASIC) N330. Via signal N320, the latter may query N300, which, in turn, must reply to N300 via N321. Such a query may be a computational task, whose correct result is to be delivered by N300 via N321 within a specified time interval. N330 may verify the correctness of this result independently of N300. For example, the results are stored in N330, or N330 may compute them itself. A fault is recognized when an incorrect value is detected. What is special about the proposed query-reply communication is that the mode signal is observed in parallel to the reply. The queries may be posed in such a way that, in order for N300 to reply, it must assume certain modes. Thus, it is possible to reliably check that all mode changes are operative, and that the mode changes provided in the program flow are in fact carried out. Especially during initialization of a system, but also during operation, this may be used as an essential component of a security concept.

Another application of this idea is the evaluation of the mode signal in an actuator control. In many applications in the automotive sector, there is currently a trend to use so-called intelligent actuators. These actuators require a minimal amount of electronics which suffices for receiving an actuator control instruction, and then for driving the actuator in such a way that this control instruction is then also executed.

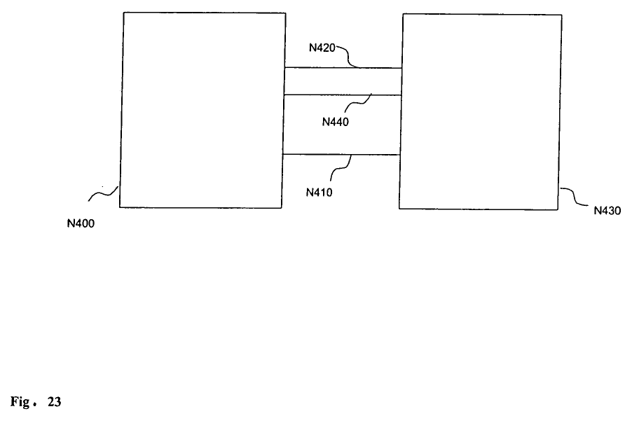

A fundamental aspect is illustrated in FIG. 23. Via connection N420, a processing unit N400 in accordance with the exemplary embodiments and/or exemplary methods of the present invention transmits a control instruction to an (intelligent) actuator or to an actuator control N430. In parallel thereto, it transmits the mode signal to this actuator via connection N410. On the basis of the mode signal, actuator N430 checks whether the control is permitted and, via signal N440, optionally returns an error status. In response to a faulty control, it assumes the fail-silence state that is not critical in the system.

1-9. (canceled)

10. A device for performing switchover operations in a computer system having at least two execution units, comprising:
a changeover switch to switch between at least two operating modes, a first operating mode corresponding to a comparison mode, and a second operating mode corresponding to a performance mode;
a comparator that is activatable in the comparison mode; and
a switchover detection arrangement to provide for desired switchover detection to control the changeover switch to switch from one of the operating modes to another of the operating modes.

11. The device of claim 10, wherein the switchover detection arrangement and the changeover switch are combined in one component or structural unit of the computer system.

12. The device of claim 10, wherein the comparator and the changeover switch are combined in one component or structural unit of the computer system.

13. The device of claim 10, wherein the switchover detection arrangement and the comparator are combined in one component or structural unit of the computer system.

14. The device of claim 10, wherein the comparator, the switchover detection arrangement, and the changeover switch are combined in one component or structural unit of the computer system.

15. The device of claim 10, wherein, in the computer system, data and instructions are processed in two pipelines, the pipelines being set up in different stages, and the switchover detection arrangement corresponds to a separate pipeline stage.

16. A method for performing switchover operations in a computer system having at least two execution units, the method comprising:
performing the switchover operations between at least two operating modes, wherein a first operating mode corresponds to a comparison mode, and a second operating mode corresponds to a performance mode; and
activating a comparator in the comparison mode;
wherein a switchover detection arrangement and a changeover switch controlled by the switchover detection arrangement switch the system from one of the operating modes to another of the operating modes.

17. The device of claim 10, wherein the switchover detection arrangement generates a switchover signal which triggers a switchover operation by the changeover switch.

18. The device of claim 10, wherein the comparator and the changeover switch are combined in one component of the computer system to form a switchover and comparison unit, and the switchover detection arrangement generates a switchover signal to trigger a switchover operation by the switchover and comparison unit.
